(19) United States
(12) Patent Application Publication
(10) Pub. No.: US 2026/0111540 A1
(43) Pub. Date: Apr. 23, 2026

(54) MACHINE LEARNING BASED CLASSIFICATION SYSTEM TO DIFFERENTIATE COMPROMISED FROM INTENTIONALLY MALICIOUS WEBSITES

(71) Applicant: Palo Alto Networks, Inc., Santa Clara, CA (US)

(72) Inventors: Shresta Bellary Seetharam, Sunnyvale, CA (US); Mohamed Yoosuf Mohamed Nabeel, San Jose, CA (US); William Russell Melicher, Sunnyvale, CA (US); Oleksii Starov, Sunnyvale, CA (US); Zhenhua Chen, Milpitas, CA (US)

(21) Appl. No.: 18/922,184

(22) Filed: Oct. 21, 2024

(51) Int. Cl. G06F 21/55

(52) U.S. Cl. CPC G06F 21/554; G06F 2221/034

(57) ABSTRACT

A plurality of features associated with a uniform resource locator (URL) are extracted. It is determined that the plurality of features associated with the URL do not match a known campaign. In response to determining that the plurality of features associated with the URL do not match a known campaign, a machine learning model is utilized to determine whether the URL is infected. The URL is labeled as being infected based on an output of the machine learning model. A URL classification database is updated based on the URL label. Network access to the URL is controlled based on the URL label.

### BACKGROUND OF THE INVENTION

Security vendors supply and maintain networks on behalf of their customers. One aspect of maintaining a network is ensuring the security of the network. Network users often access a Uniform Resource Locators (URL) and visit resources, such as a website, on public networks, such as the internet, using devices associated with a network. Malicious parties may own URLs that exploit the resource visitor's device and the device's network. Malicious parties may also compromise legitimate URLs not owned by a malicious party, thus infecting the URL. The infected URL may be configured to exploit the visitor's device and the device's network.

In order to ensure that their customers are not exposed to malicious activity from public networks, security vendors attempt to classify URLs as malicious or benign. Security vendors use these classifications to determine access to URLs. When a URL links to a legitimate resource that has been infected, it can be challenging to correctly classify the URL as malicious or benign.

It is desirable for security vendors to correctly classify URLs as malicious or benign at any given time, especially when the customer accesses the URL often. If the URL of a legitimate resource is labeled malicious when it is actually benign (i.e. false positive), the customer will be unsatisfied with the security vendor's product. Conversely, if the URL of a legitimate resource is labeled benign when it is actually malicious (i.e. false negative), the security vendor may have failed to secure the customer's network from malicious activity.

### BRIEF DESCRIPTION OF THE DRAWINGS

Various embodiments of the invention are disclosed in the following detailed description and the accompanying drawings.

FIG. 1 is a flow diagram which illustrates a network user attempting to access a URL in accordance with some embodiments.

FIG. 2 is a flow diagram illustrating a network user attempting to access a URL and submitting a change request in accordance with some embodiments

FIG. 3 is a block diagram illustrating a system that facilitates network security when relating to the access of URLs in accordance with some embodiments.

FIG. 4 is a flow diagram illustrating a process for determining the classification of a URL in accordance with some embodiments.

FIG. 5 is a timeline illustrating the lifecycle of a URL along with its security classification in accordance with some embodiments.

FIG. 6A-6C illustrate examples of legitimate URLs that can become infected at any time in accordance with some embodiments.

FIG. 7A-7C illustrate examples of attacker owned URLs that can be classified as malicious in accordance with some embodiments.

FIG. 8 depicts examples of clusters that can be generated by a graph database in accordance with some embodiments.

FIG. 9 depicts examples of clusters that can be generated by a graph database in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Systems and methods to classify URLs with an associated security status are disclosed herein. The systems and methods discussed herein enable a security vendor to increase the accuracy of URL classification. Users often use devices on a private network to access URLs on the public network, such as the internet. When a network user accesses a malicious URL, the URL's resource can expose the user's device and the user's network to malicious activities.

Examples of malicious activities include data exfiltration, web skimming, cryptomining, clickjacking, etc. It is desirable that security vendors prevent network users from being exposed to malicious activity on the internet.

To advance this objective, a security vendor can classify a plurality of accessible URLs with an associated security status. Two classifications are malicious and benign. However, URLs may have other classifications as well, such as grayware. A malicious URL can be further classified as malicious attacker owned or malicious infected. The security vendor may store the URLs and their classifications so that when a network user attempts to access a URL, the security vendor can determine whether the URL poses a security threat. The security vendor can configure the network to block access to URLs which pose a security threat.

Malicious URLs direct to resources which can expose visitors or their networks to malicious activity. Benign URLs direct to resources which do not expose visitors nor their networks to malicious activities. Malicious URLs can be further classified as attacker owned (malicious attacker owned) or infected (malicious infected). An attacker owned URL is a URL that exists for the primary purpose of exposing visitors to malicious activities. An infected URL directs to a resource that has been compromised by a malicious party and is currently configured to expose visitor devices or their networks to malicious activity.

A malicious URL may also be malicious because the URL exposes visitors to malware. Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks.

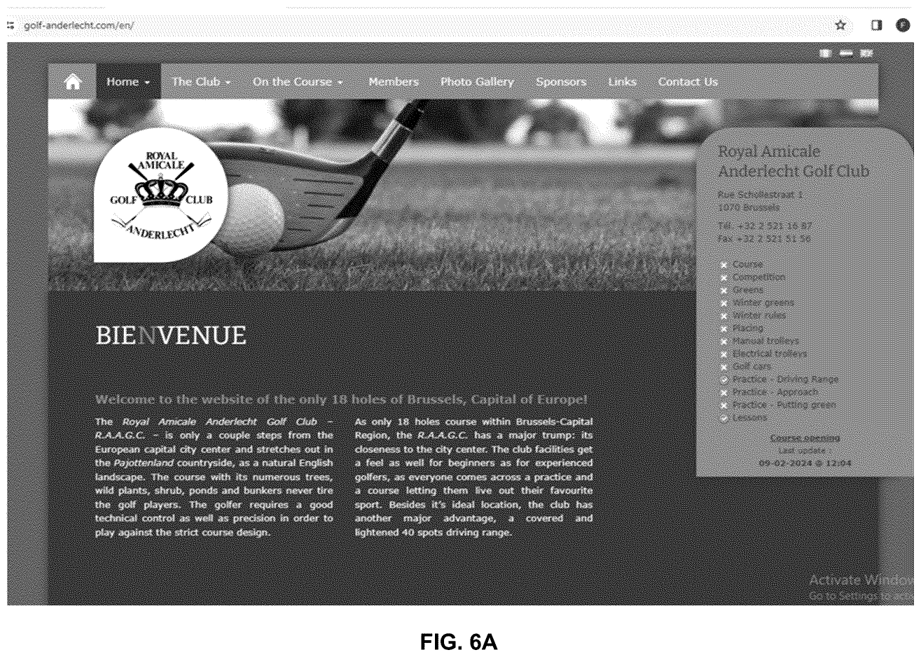

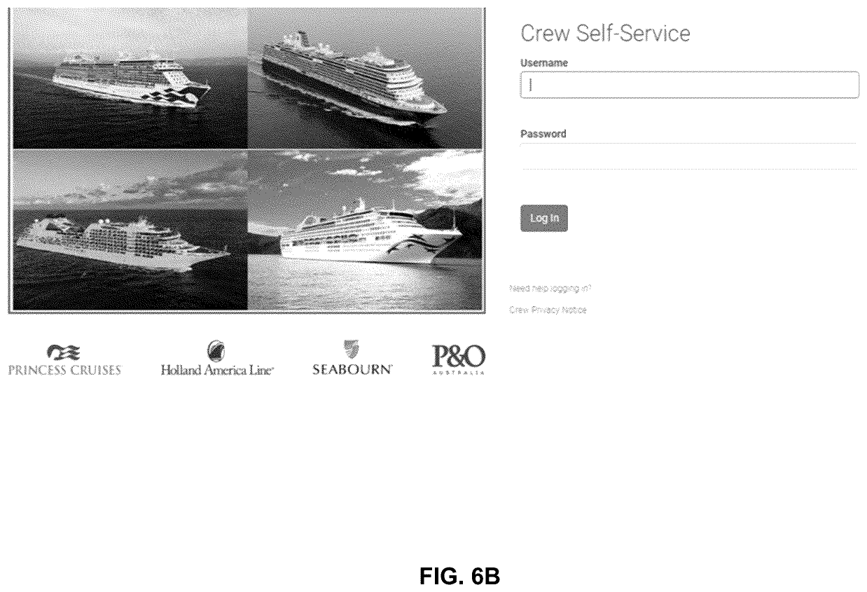

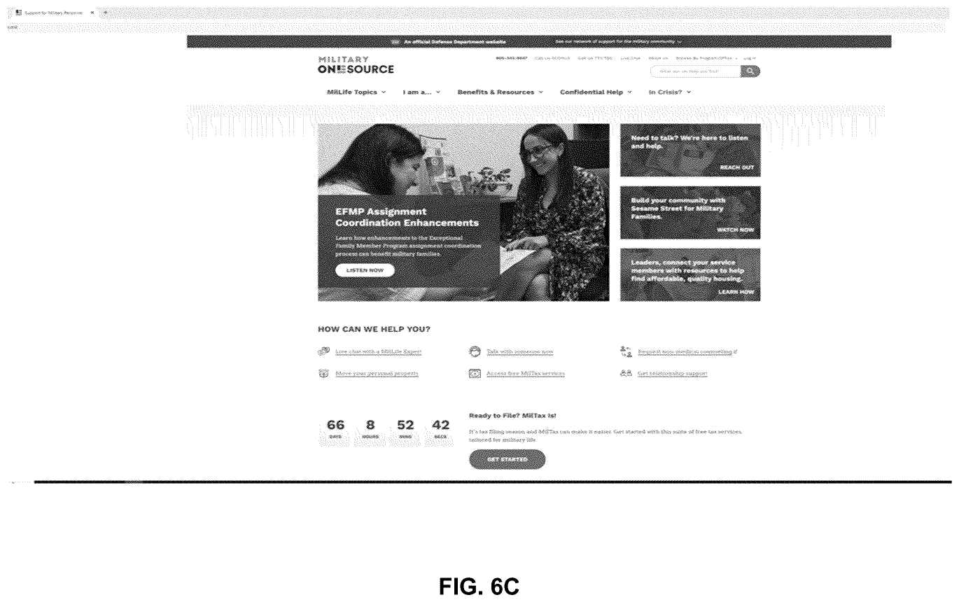

Legitimate URLs direct to resources that are legitimately owned and operated, such as Facebook's website. A security vendor often classifies a legitimate URL as benign and allows access to the URL because network users expect to be able to access legitimate resources. Unfortunately, a legitimate URL can become infected at any time. Examples of a legitimate URL that may be infected are shown in FIGS. 6A-6B.

When a legitimate resource becomes infected, it is desirable that the security vendor learns of the infection and reclassifies the legitimate URL (e.g. from benign to malicious) from the second classification to the first classification. However, at any time after an initial reclassification, the true security status associated with the URL may change once again. At that point the security vendor may need to reclassify the URL again (i.e. from malicious to benign) from the second classification to the first classification. Oftentimes when a legitimate URL is malicious, it is malicious infected and not malicious attacker owned.

The security vendor may need to reclassify the URL again, because the owner of the URL may have cleared the resource of the infection, thereby eliminating the security threat associated with the URL. A legitimate owner may clear a resource of the infection at any time. Therefore, the security vendor must expend resources to ensure that legitimate URLs are classified correctly at any given time.

When a network user attempts to access a legitimate URL, the user may be blocked by the security vendor because the URL has been classified as malicious. In some cases, the network user accesses this URL often. Therefore, after being blocked, the network user may become unsatisfied with the security vendor's service. Often times, the network user will contact the security vendor directly. The security vendor must expend resources to address the network user's concerns.

In order to address the network user's concerns, an employee of the security vendor may have to investigate the true security status of a legitimate URL. In response to a determination that the URL is benign, it becomes known to the security vendor that the URL was misclassified as malicious, i.e., a false positive (FP). In response to a determination that the URL is properly classified as malicious i.e., a true positive (TP), the security vendor may expend additional resources (e.g. human resources) to contact the URL owner, ensure that the resource is cleaned of the infection, and/or reclassify the URL from malicious to benign once the security vendor determines that the URL is safe to visit. When a URL is correctly classified as benign, it is a true negative (TN).

Sometimes a security vendor classifies a legitimate URL as benign, even though the resource is currently compromised (e.g. it was infected and has not been cleaned up). Such a misclassification is a false negative (FN). A security vendor still allows network users to access a legitimate URL when it is a FN because it has not determined that the legitimate URL is malicious. Upon access, the user's device and the user's network are exposed to malicious activity.

While it is undesirable for a security vendor to misclassify a legitimate URL as malicious, it is desirable for the security vendor to classify ground truth malicious URLs as malicious in order to secure the network from malicious activities.

It is also desirable for a security vendor to differentiate between URLs that are malicious attacker owned and malicious infected. This is because infected malicious URLs have a fluid security status (i.e. they often switch between ground truth benign and ground truth malicious). This increases the amount of misclassifications by the security vendor. Furthermore, malicious infected URLs are often legitimate URLs that experience high traffic by customers of the security vendor. Therefore, it is desirable for the security vendor to block access when the potentially infected URL is malicious and allow access when it is benign. The systems and methods disclosed herein allow a security vendor to differentiate between URLs that are malicious attacker owned and malicious infected.

It is challenging to maintain correct classifications of URLs for a variety of reasons. For example, the true security status of a URL (e.g. when a URL is malicious infected) is fluid and can change at any time without notification to the security vendor. Another reason is that malicious parties are constantly attempting to expose URL accessors to malicious activity. Malicious parties are sophisticated and are able to respond to current methods of detection used by security vendors. Malicious parties modify campaigns to avoid detection and create brand new campaigns which may completely bypass old detection methods.

An attacker may also purposefully remove the malicious activity from an infected URL, so that security vendors change the classification associated with the URL back to benign. Once the classification is changed to benign, the URL will have more visitors, and the attacker can re-infect the URL to expose the visitors to malicious activities.

Security vendors often employ network security pipelines to classify URLs. Occasionally, URLs are misclassified. Misclassification of URLs (e.g. FN and FP) causes increased expenditure for dealing with unhappy users, and vulnerable networks. The systems and methods disclosed herein apply Machine Learning (ML) techniques to improve the accuracy of URL classification.

In some embodiments, a security system receives a URL, collects content and metadata associated with the URL, and determines whether a URL is benign or malicious based on the content and metadata associated with the URL. In response to a determination that the URL is benign, the security system classifies the URL as benign and permits users to access the URL.

In response to a determination that the URL is malicious, the security system uses the content and metadata associated with the URL to produce/generate/determine features and signatures. The security system determines if the signatures or features match those of a known campaign. In some embodiments, in response to a determination that the signatures or features match a known infected campaign, the URL is classified as malicious infected. In some embodiments, in response to a determination that the signatures or features match a known attacker owned campaign, the URL is classified as malicious attacker owned. In response to a determination that it is not infected with a known campaign, the security system provides the URL, its content, and metadata to one or a number of ML models.

One or a number of ML models may be trained on malicious infected and malicious attacker owned URLs. The security system queries one or a number of ML models to determine if the URL is infected or attacker owned. The security system classifies the URL in accordance with the ML model's determination. In response to a determination that the URL is malicious infected, the URL may also be used as training data to improve the accuracy of the model.

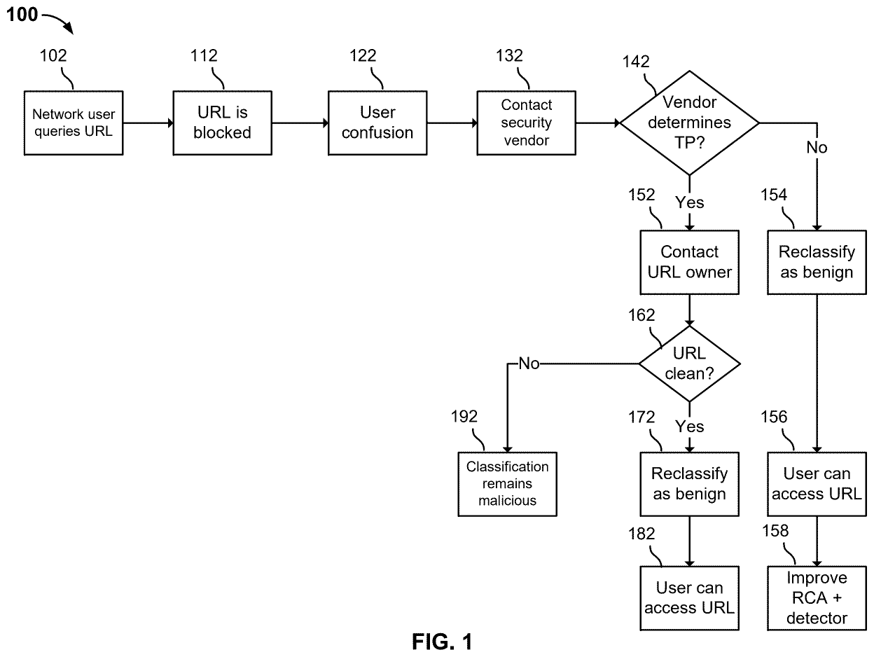

FIG. 1 is a flow diagram which illustrates a network user attempting to access a URL in accordance with some embodiments. In some embodiments, a network user accesses public resources, such as those found on the internet, using a device which is part of a private network or has access to a private network. The security vendor ensures the security of the network by monitoring all incoming and outgoing network traffic. In some embodiments, the security vendor allows its customers to directly contact the security vendor when the customer is blocked from accessing a URL.

Oftentimes, the URL is a legitimate URL which the network user frequently accesses. If the URL queried by the user is associated with a legitimate URL, it is critical for the security vendor to ensure that access is not blocked due to FP's. However, a legitimate URL may become infected at any time. Thus, it is similarly critical for the security vendor to rapidly address the potential security vulnerabilities of a URL when it is a TP. This is because the security vendor strives to supply a competitive product that minimizes customer confusion while ensuring a secure network.

This is facilitated by knowing whether a malicious URL is malicious infected or malicious attacker owned.

At 102, a network user attempts to query a URL. In some embodiments, a network user is any device which has access to a network. A device may be a computer, mobile device, server, Internet of Things (IoT) device, etc. A device can be any device capable of querying a URL. It need not be a person; a network user can be an application that runs on a computer and attempts to access a URL. For example, an automated process that accesses the URL of a data provider is a network user. In some embodiments, the queried URL is a legitimate URL.

A legitimate URL is any URL that is associated with a resource, such as a website, that does not exist for the purpose of performing malicious activities. Malicious activities include data exfiltration, web skimming, cryptomining, clickjacking etc.

Examples of legitimate URLs are those of many commonly known websites, such as Google's website, Facebook's website, Amazon's website, etc. However, any URL that exists for another reason other than performing malicious activities can be a legitimate URL. For example, a WordPress website set up by a merchant to sell homemade goods has a legitimate URL. Some legitimate websites are only accessible by particular users. For example, a company may own a legitimate URL which directs to a website only accessible on a certain network. The website may be exclusively used as a portal for company's employees to log hours.

In some embodiments, the owner of a legitimate URL is a customer of the security vendor which also acts as a network provider for a network user. The systems and methods disclosed herein can be used to provide security services to network users and URL owners. For example, in response to a determination that a legitimate URL is malicious, the security vendor may contact the URL owner and provide advice or services to clean up the URL.

FIGS. 6A-6C illustrate examples of legitimate URLs that can become malicious infected at any time in accordance with some embodiments. The websites in FIGS. 6A and 6C are examples or legitimate websites that exist for legitimate purposes such as booking a tee time or shopping.

The website in FIG. 6B is a company portal which can be used by company employees to access self-service. This website can become infected with an exploit, such as a watering hole attack, and expose network users and the private network to malicious activity upon access.

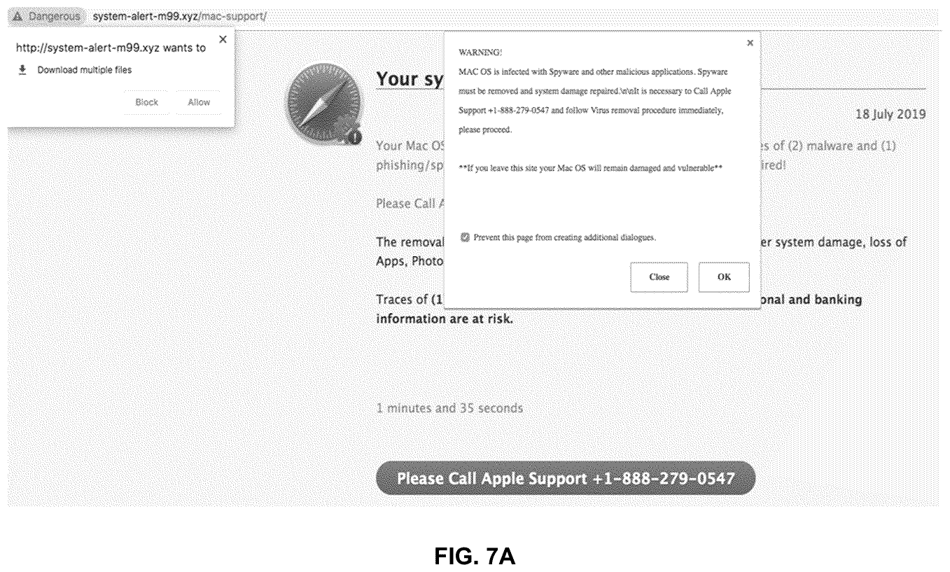

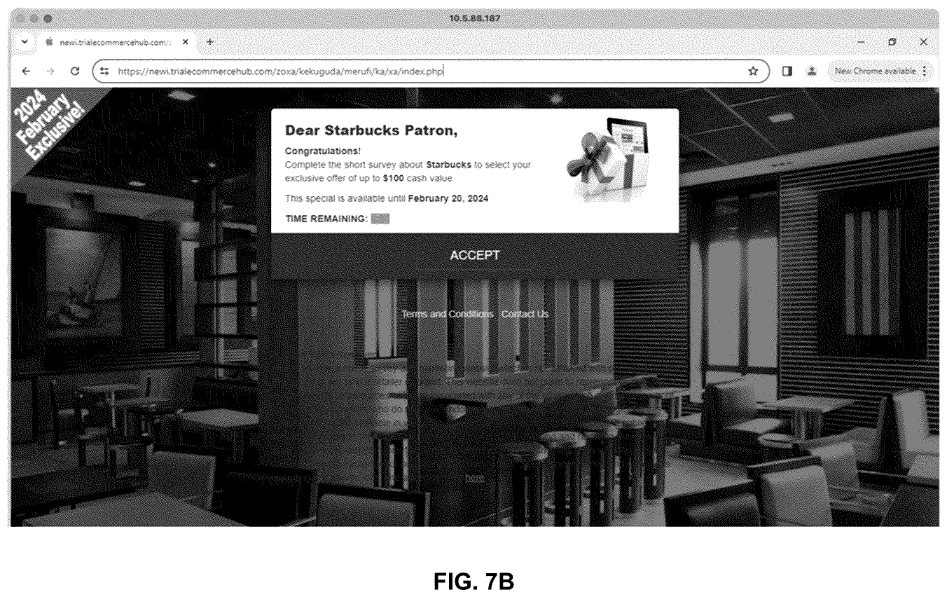

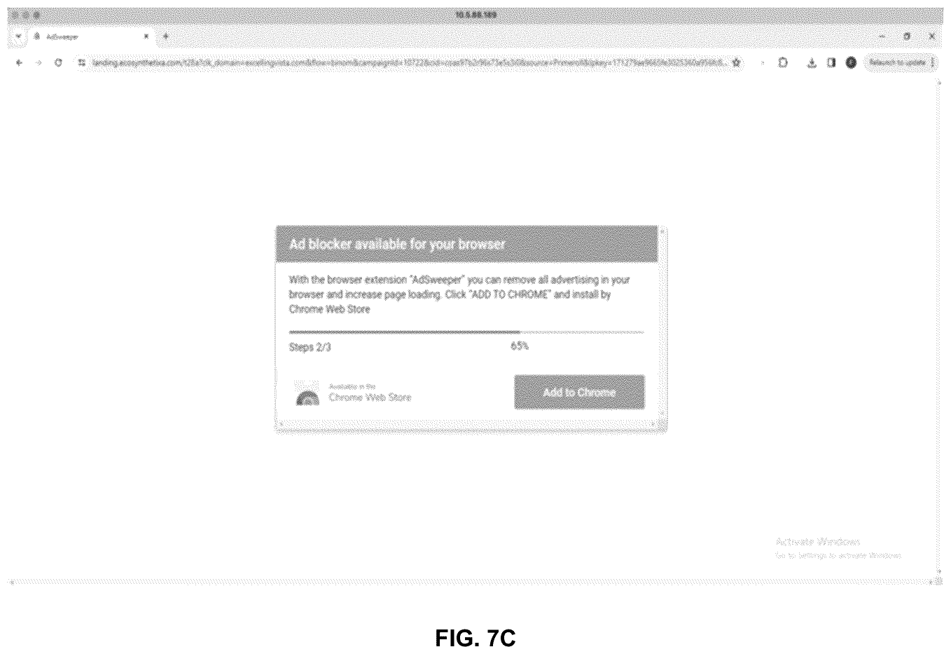

FIGS. 7A-7C illustrate examples of attacker owned URLs that can be classified as malicious attacker owned in accordance with some embodiments. The websites in FIGS. 7A-7C are malicious websites that expose visitors to malicious activities. In some embodiments an attacker owned website baits unwitting visitors to click on malicious links which may cause malware to be downloaded on the visitor's device, thus infecting the device and the network. In some embodiments, security vendors identify attacker owned websites using the indicators of compromise (IOCs) present on the website. FIG. 7A is an example of an attacker owned website that exhibits several IOCs.

At 112, the security vendor blocks a network user from accessing a URL and its associated resource. In some embodiments, the security vendor scans a plurality of URLs at an earlier time and stores classification information. The classification information is used by the network to determine access to a particular URL when a network user queries the URL. In some embodiments, the security vendor blocks access to a particular URL when the security vendor has reason to suspect that a URL is engaged in malicious activity.

In some embodiments, the security vendor's database contains a false classification for the queried URL. In some embodiments, the database misclassifies a ground truth malicious URL as benign (FN) and allows a network user to access the malicious resource. In some embodiments, the database misclassifies a ground truth benign URL as malicious (FP) and blocks a network user from accessing the benign resource. In some embodiments, the database correctly classifies a URL as malicious (TP), and blocks access to the malicious resource. False classifications can occur due to a lack of insight into whether the URL is malicious attacker owned or malicious infected.

Process 100 is an example of an embodiment where the security vendor classifies a URL as malicious (either malicious infected or malicious attacker owned), and blocks access to the URL which the network user is attempting to access.

At 112, the network blocks access to a URL either because of a TP or a FP. In some embodiments the URL queried at 102 is a legitimate URL which is associated with a legitimate resource (e.g. websites of FIG. 6A-6C). In some embodiments, the network user frequently accesses the URL and becomes confused when the access is prevented by the security vendor. In some embodiments, the network user believes that the security vendor has mistakenly blocked the legitimate URL.

For example, a company employee frequently accesses the URL for a company portal website. On one occasion, upon querying the company portal website, the employee is blocked and is notified that the company's security vendor has blocked access to the company portal website. The company employee believes that the security vendor is misclassifying the company portal website as an FP.

A network user's confusion leads the user to contact the security vendor. The network's user may have been met with a message that indicates that the security vendor has classified the URL as malicious and has blocked access. This experience may lead a security vendor's customer to question the quality of the security vendor's network and services.

At 132, the network user contacts the security vendor. The network user may contact the security vendor through any means of communication (e.g. phone, email, customer service hotline, etc.).

The network user contacts the security vendor and expresses concern because access to a legitimate URL is blocked. The security vendor must expend resources to receive and address the unsatisfied customer's concern. Oftentimes, the security vendor may elevate the customer's complaint through the company. A crucial employee, such as software engineer, researcher, or analyst, may be tasked with addressing the customer's complaint. In some embodiments, the crucial employee must analyze the URL and the security vendor's classification associated with the URL.

At 142, the security vendor investigates the URL queried at 102. In the course of this investigation, the security vendor may find that the URL was classified as malicious infected. In some embodiments, this determination is made by a crucial employee, such as a software engineer, who expends resources to analyze the URL and the security vendor's classification associated with the URL. Often times, the crucial employee must have the requisite technical knowledge to analyze whether a legitimate URL has been infected and is currently compromised.

A legitimate URL can be infected in a novel manner that has never been seen before by the security vendor. In these cases, a crude method for classifying URLs will classify the URL as malicious attacker owned. Thus, the security vendor will not know that the URL is actually malicious infected. This leads to further confusion within the security vendor.

At 154, in response to a determination that the URL classification is not a TP (i.e. the classification is a FP), the security vendor reclassifies the URL as benign. This FP can occur due to human error, such as a bad signature or a machine error, such as a ML model FP.

In some embodiments, an FP arises because the URL was correctly classified as malicious, but since the classification, the resource was modified, likely by the process of an infection clean up, so it is now benign. This occurs frequently with malicious infected URLs. Therefore, a security vendor can use a system which differentiates malicious between malicious infected and malicious attacker owned to anticipate these FP's and deal with them in a more cost efficient manner.

At 156, the network user is able to access the URL because the security vendor has determined that the URL is ground truth benign, reclassified the URL as benign, and allowed access to the URL.

At 158, the security vendor uses any information garnered from the process executed to address the FP in order to improve an initial process which led to the misclassification associated with the URL.

Referring back to 142, in response to a determination that the URL is classified as a TP, the security vendor proceeds to 152. A security vendor determines that the blocked URL was a TP when it finds that the URL was properly blocked because it is malicious.

At 152, an employee at the security vendor informs the owner associated with the URL and that their URL is malicious infected. In previous systems, it would take a resource intensive process (e.g. human resources) to determine if it is expedient to contact the owner of a URL that is classified as malicious. This is because the security vendor would need to determine whether or not the URL is malicious attacker owned or malicious infected.

The systems and methods disclosed herein can be used to differentiate between malicious attacker owned and malicious infected. This may mitigate the costs of determining whether it is expedient to contact the URL owner. The systems and methods disclosed herein can also produce evidence of why the URL is classified as malicious. This evidence can be used to advise the infected URL owner.

In some embodiments, a resource associated with a URL is considered cleaned up when the possibility of the resource engaging in malicious activities is eliminated. For example, if a website is injected with malware, the website is effectively cleaned up when the malware is located and removed.

In some embodiments, step 152 is optional.

At 162, the security vendor decides whether the URL has been successfully cleaned up. In response to a determination that the URL is still malicious, the security vendor proceeds to 192 and does not reclassify the URL. At 192, the network user is still blocked from accessing the URL. This is necessary to ensure the security of the network user's device and of the network as a whole.

In response to a determination that the URL is benign, the security vendor proceeds to 172 and reclassifies the URL as benign. At 172, the security vendor proceeds in a manner similar to 154. When the process reaches 172, it is apparent that the initial determination was correct because it classified a malicious URL as malicious (TP).

At 182, the network user is able to safely access the legitimate URL because the security vendor changed the classification associated with the URL from malicious to benign.

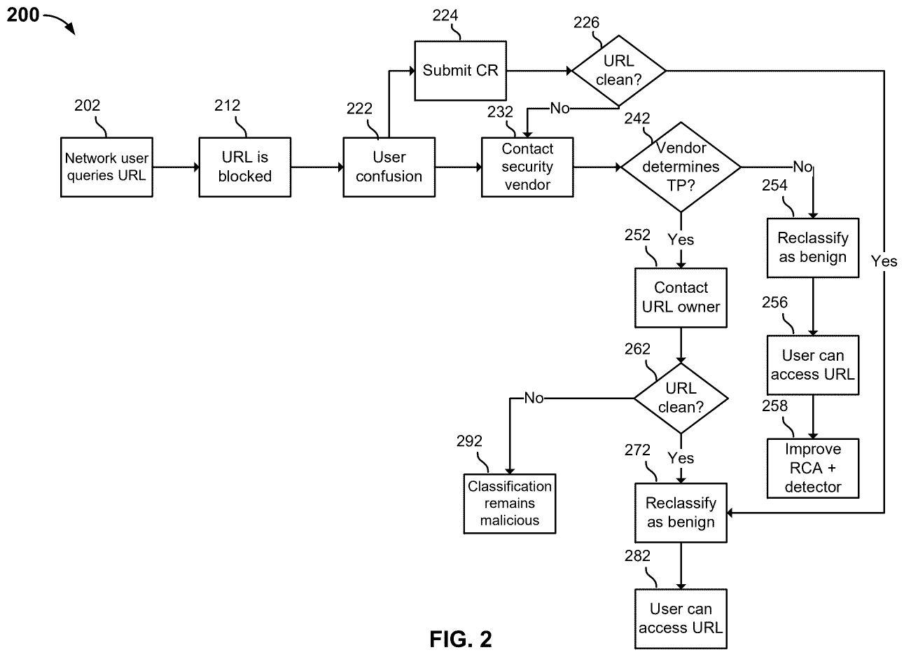

FIG. 2 is a flow diagram illustrating a network user attempting to access a URL and submitting a change request in accordance with some embodiments. In process 200, a network user submits a change request (CR) to a security vendor. A security vendor may set up a system which allows its customers to submit CRs. A CR is submitted in an effort to request the security vendor to change the security classification of a particular URL so that the user can gain access to the site.

In some embodiments, a party submits a CR when the party (e.g. URL owner, customer, etc.) believes that a URL that is classified as benign is ground truth malicious. This is a FN CR. In some embodiments, a party submits a CR when the party (e.g. URL owner, customer, etc.) believes that a URL that is classified as malicious is ground truth benign. This is a FP CR.

The CR system may be automated. In some embodiments, the CR system is a website that functions as a re-analysis request portal where a security vendor's customers can report URLs when the customer believes that the URL has been misclassified as a FN or FP. In some embodiments, the CR system feeds a security system a stream of potentially malicious infected URLs.

At 202, a network user, such as a human, queries a URL.

At 212, the network user is blocked from accessing the URL. In some embodiments, the security vendor blocks the network user from accessing the URL because the URL is classified as malicious. In some embodiments, the URL classification is a FP. In some embodiments the URL classification is a TP.

At 222, the network user is confused because it has been denied access to a URL. Often times, the URL is a legitimate URL which the network user frequently accesses.

Process 200 illustrates an example in which the network user submits a CR to the security vendor or decides to contact the security vendor directly. Process 200 illustrates these processes may interact to cause the security vendor unnecessary redundancies in addressing customer concerns.

At 224, the network user submits a CR to the security vendor. In some embodiments, the network user indicates that it believes a particular URL is blocked due to a FP. In some embodiments, the URL and its suspected misclassification are fed into a stream of URLs. In some embodiments, the security vendor maintains and stores this stream of URLs submitted through a CR system for future use.

At 226, the security vendor addresses a CR by determining whether the URL is clean. The URL is clean when the security vendor determines that the URL does not expose the accessor to malicious activities. In some embodiments, an automated process is used to determine if the URL is clean after a CR is submitted. For example, a detector that was previously used to make the initial determination associated with the URL may be used again on the URL. In some embodiments, human resources are expended to determine if a URL is clean. In some embodiments, the CR system is in place to reduce the costs of addressing the ramifications of misclassifications.

Again, at 226, it is advantageous for a security vendor to be able to efficiently determine if the URL is malicious attacker owned or malicious infected, because the ideal process to efficiently deal with each scenario can be different.

In response to a determination that the URL is clean, process 200 proceeds to step 272. At 272, the security vendor reclassifies the URL as benign.

At 232, a network user contacts the security vendor because it is still denied access to a URL. This may occur because the network user is not satisfied with the result of the CR. Step 232 may also be reached in a similar manner to process 100.

Sometimes, step 232 occurs when the CR has not been addressed in a timeframe that satisfies the network user, so now the security vendor must deal with the same URL at two points in a network security pipeline. This scenario is undesirable for a security vendor because the network user's confusion has caused an unnecessary redundancy in the security vendor's web security pipeline. This redundancy may accrue additional expenses to properly address.

At 242, the security vendor expends resources to determine if the classification associated with the URL was a FP or a TP. In some embodiments, the description of step 142 of FIG. 1 applies to step 242. In some embodiments, the security vendor expends additional resources to determine if the URL is ground truth benign or correctly classified as malicious.

In response to a determination that the URL classification is not a TP (i.e. FP), the security vendor proceeds to step 254. At 254, the security vendor reclassifies the URL as benign. After step 254, the network user is able to access the URL.

At 258, the information garnered from the process of analyzing the URL is applied to help improve the systems in place that initially caused the misclassification.

Referring back to 242, in response to the determination that the URL was correctly classified as malicious in an earlier classification, the process proceeds to step 252. In some embodiments, step 252 occurs between step 232 and step 242.

In some embodiments, the description of step 152 of FIG. 1 applies to step 252. In some embodiments, the security vendor contacts the URL owner, informs them that the URL is malicious, and asks the URL owner to clean up the website.

At 262, the security vendor determines whether the URL is now clean. In response to the determination that the URL is clean, the security vendor proceeds to 272 and reclassifies the URL as benign. After step 272, the user can access the URL (282).

In response to a determination that the URL remains malicious, the process proceeds to 292. At 292, the URL's classification remains malicious, and the network user is unable to access the URL.

Some aspects of process 100 and process 200 are undesirable for a security vendor. When executing processes 100 and 200, the security vendor must expend additional resources, especially human resources, to ensure that URLs are classified correctly and respond to the ramifications when a URL is misclassified (FP or FN).

It is desirable for a security vendor to be able to quickly assess whether the URL is malicious attacker owned or malicious infected. This knowledge can be used to provide web security for clients in a more cost effective manner, because legitimate URLs that are classified as malicious merely because they are infected can be dealt with differently than attacker owned URLs.

In some embodiments, a web security pipeline (e.g. process 100 and 200) is enhanced through the use of a machine learning (ML) model which can be configured to determine whether a malicious URL is malicious attacker owned or malicious infected.

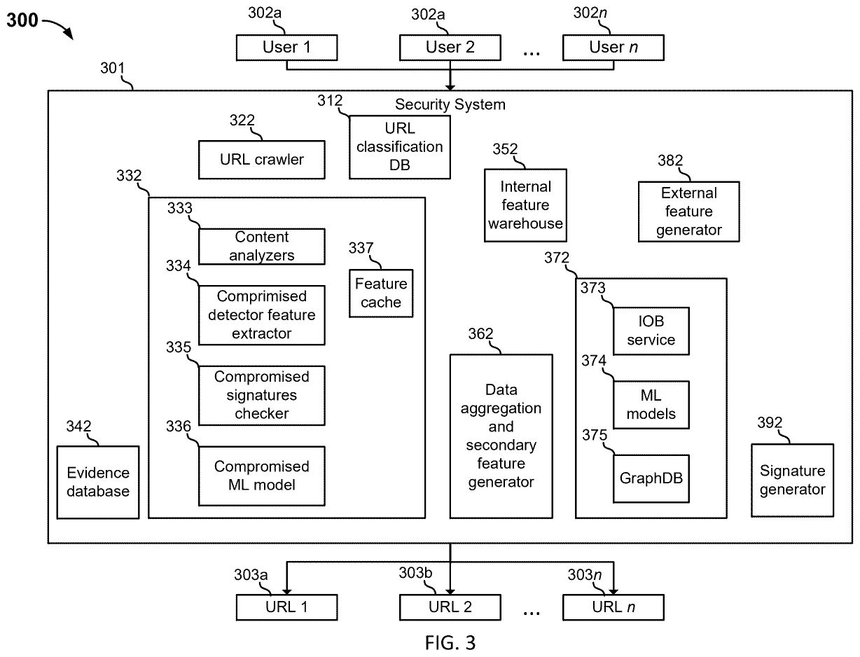

FIG. 3 is a block diagram illustrating a system that facilitates network security when relating to the access of URLs in accordance with some embodiments. In some embodiments, security system 301 receives a request for a URL, such as URL 303a, 303b, . . . , 303n, from network user, such as user 302a, 302b, . . . , 302n, queries the URL on URL classification database (DB) 312, and determines access based on the security classification associated with the URL in URL classification DB 312. In some embodiments, security system 301 populates URL classification DB 312 with URLs and their security classifications using components depicted within security system 301. In some embodiments, security system 301 receives a request for a URL and uses one or more components to reach a verdict on the classification associated with the URL. In some embodiments, security system 301 classifies URLs as benign, malicious, malicious attacker owned, malicious infected, grayware, etc.

In some embodiments, security system 301 continuously classifies a continuous stream of URLs from URL crawler 322. In some embodiments, components within security system 301 can be used to classify or reclassify a single URL. For example, if a network user submits a CR, URL classifier 332 can be used to reclassify the URL and change the URL's entry in URL classification DB 312.

In some embodiments, security system 301 is configured to receive an unclassified URL. Security system 301 is configured to determine that the URL is unclassified when there is no corresponding entry in URL classification DB 312. After receiving an unclassified URL, URL classifier 332 is configured to classify the URL. In some embodiments, content analyzers 333 are configured to extract content and metadata associated with the URL. In some embodiments, content analyzers 333 use the extracted content and data and determine that the URL is either benign or malicious.

In response to a determination that the URL is malicious, the URL and its associated information are forwarded to compromised detector feature extractor 334. The term infected is may be interchangeable used with the term compromised.

In some embodiments, compromised detector feature extractor 334 is configured to extract one or more features from information associated with the URL. In some embodiments, the URL, information associated with the URL, and the features are forwarded to compromised signatures checker 335.

Compromised signatures checker 335 is configured to receive the URL, information associated with the URL, and the products of compromised detector feature extractor 334. Compromised signatures checker 335 can determine if the proper URL classification is malicious infected, by referring to known campaign signatures. A URL is infected with a known campaign when it exhibits one or more signatures associated with a known campaign. In some embodiments, signatures are generated on the fly by signature generator 392. In some embodiments, signatures are human reviewed and added to compromised signatures checker 335.

In response to a determination that a URL exhibits known campaign signatures, the URL is classified as malicious infected.

In some embodiments, the URL does not exhibit any known campaign signatures. In response to a determination that the URL does not exhibit known campaign signatures, the URL, information associated with the URL, and derived information about the URL (e.g. products of content analyzers 333 and compromised detector feature extractor 334) are forwarded to compromised ML model 336.

Compromised ML model 336 is configured to infer whether a URL is malicious infected or malicious benign. In some embodiments, compromised ML model 336 receives features which describe the URL and performs inference of the classification associated with the URL. The inference can be used by security system 301 and a security vendor to more efficiently manage a web security pipeline such as process 100 and process 200.

URL crawler 322 is a device configured to crawl networks, such as the internet. In some embodiments, URL crawler 322 functions as a web-browser with an automated user (i.e. a fully automated web driver). When URL crawler 322 interacts with a URL, it can simultaneously record all data arising from its interactions. To illustrate, URL crawler 322 can be provided with a URL, access the URL, simulate mouse and keyboard inputs (i.e. to interact with a website), record all actions that the URL takes on a web browser, record all reactions to interactions with the website, etc. For example, URL crawler 322 can access a website and “click” on every hyperlink on the website and record what the website does. In some embodiments, URL crawler 322 can be queried by any component in security system 301 to perform web driver tasks.

In some embodiments, URL crawler 322 creates extensive crawl logs which describe a crawl of a URL. URL crawler 322 crawl logs may contain a wide variety of information, such as networking traffic associated with the URL (e.g., HTTP requests sent and received), HTML, CSS, JavaScript, metadata of site access (e.g. when the crawl occurred), links to subdomains and what those subdomains contain, links to other URLs, data concerning events from keystrokes and mouse clicks, SHAs, etc. In some embodiments, URL crawler 322 can create content and metadata by executing code associated with a URL (e.g. JavaScript) in a sandbox. The content and metadata can be created through any analysis of the code's execution (e.g. system usage, requests sent, etc.). This content and metadata may be included in the crawl log.

URL crawler 322 can be configured to crawl URLs using any partition of URLs or timing of crawling. For example, URL crawler 322 can crawl certain URLs on a schedule (e.g., daily, weekly, monthly, etc.).

In some embodiments, crawl logs are used by other components to execute a classification related process. For example, content analyzers 333 can use crawl logs to classify a URL. Crawl logs can also be used by compromised detector feature extractor 334 to extract features.

In some embodiments, content analyzers 333 is able to determine that a URL is malicious or benign. In response to a determination that a URL is malicious, security system 301 may investigate the URL further, in order to determine if it is malicious attacker owned or malicious infected.

In some embodiments, URL crawler 322 crawls a URL and forwards the URL to URL classifier 332. In some embodiments, URL crawler 322 crawls URLs such that it maintains a continuous stream of URLs. In some embodiments, URL crawler 322 continuously forwards a continuous stream of URLs to URL classifier 332. In some embodiments, URL crawler 322 forwards URLs along with information associated with the URL to URL classifier 332 (including the crawl logs).

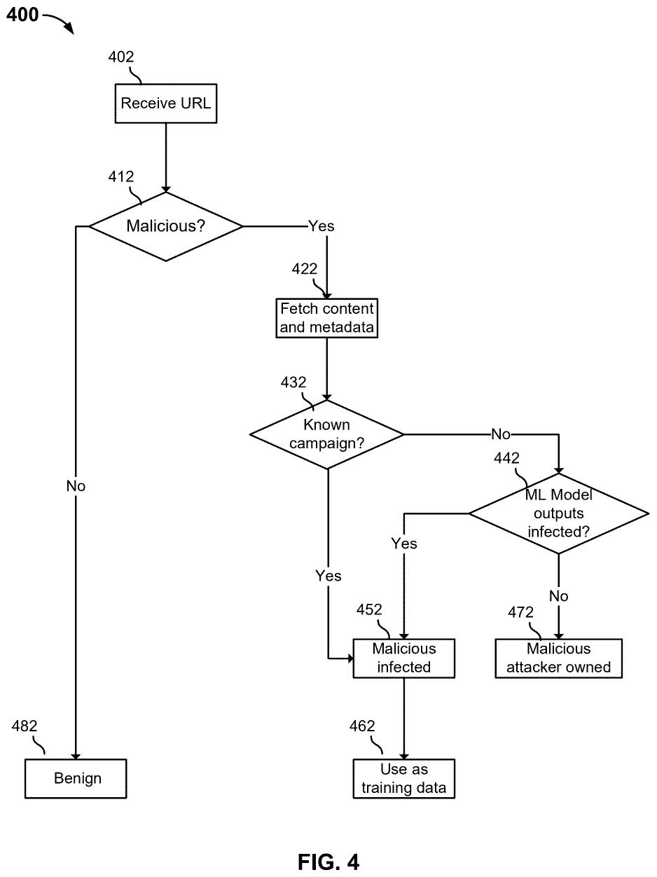

In some embodiments, URL classifier 332 is used to optimize a process such as those illustrated in FIG. 1 and FIG. 2. In some embodiments, URL classifier 332 executes process 400 in FIG. 4. In some embodiments, URL classifier 332 is used to determine a URLs classification.

In some embodiments, evidence generated by one or more components in URL classifier 332 is forwarded to evidence database 342 and stored for future use. In some embodiments, the features generated by one or more components in URL classifier 332 is forwarded to feature cache 337 and stored for future use.

Content analyzers 333 is used to analyze any content associated with a URL in accordance with some embodiments. In some embodiments, when a URL is received by URL classifier 332 it is first forwarded to one or a number of content analyzers 333. In some embodiments, content analyzers 333 is one system that analyzes content using a variety of techniques. In some embodiments, content analyzers 333 are multiple systems in communication which analyze content using a variety of techniques.

In some embodiments, content analyzers 333 classifies a URL. Content analyzers 333 can classify a URL as malicious or benign. In some embodiments, after content analyzers 333 classifies a URL as malicious, security system 301 investigates the URL further in order to determine if it is malicious infected or malicious attacker owned.

In some embodiments, content analyzers 333 query a URL and access the URL's associated resources. In some embodiments, the URL's associated resource is a web page. In some embodiments, content analyzers 333 retrieve the HTML, CSS, JavaScript etc. associated with a URL. In some embodiments, content analyzers 333 retrieve and analyze metadata associated with a URL. In some embodiments, content analyzers 333 receive information associated with the URL along with the URL. For example, URL crawler 322 may be configured to send any information associated with the URL because it has already accessed the resource. In some embodiments, content analyzers 333 receives information associated with the URL (e.g. crawl logs) from URL crawler 322.

In some embodiments, content analyzers 333 identify and catalogue content based signals and vulnerability signals in URLs. In some embodiments, content analyzers 333 caches/stores information regarding the content based signals and vulnerability signals of each URL for future use.

In some embodiments, content analyzers 333 receive data associated with a URL, such as a file. In some embodiments, content analyzers 333 parses this data and is able to interpret the data.

For example, content analyzers 333 may receive HTML, CSS, and JavaScript files from a website. Content analyzers 333 may parse all of the files and identify every occasion of a script tag in the HTML. Content analyzers 333 may then store all of the information surrounding the script tags and/or the information contained in the script tags.

In some embodiments, content analyzers 333 produce information that facilitates other components in security system 301 to execute a process. In some embodiments, content analyzers 333 may output a report associated with the URL which can be consumed by other components in security system 301. In some embodiments, the report is structured in a manner which is useful for other devices in security system 301.

For example, content analyzers 333 may generate a JavaScript Object Notation (JSON) data which indicates the location of IOCs or potential IOCs within the resources associated with a URL. Content analyzers 333 may generate data in any format, JSON, YAML, TOML, CSV etc.

As an illustration, suppose content analyzers 333 receives the resources associated with a certain URL. One of these resources is an HTML file. In the HTML file, there is a particular script tag which contains an IOC. Content analyzers 333 reads, parses, analyzes etc. the HTML file and prepares a report. The report can be consumed by another component and used in a process.

In some embodiments, content analyzers 333 can analyze URL resources by executing code in a sandbox and analyzing the results. For example, if a website contains JavaScript, content analyzers 333 can execute the JavaScript in a sandbox and record if the code sends any HTTP requests.

In some embodiments, the information produced by content analyzers 333 is used by other components within security system 301, such as compromised detector feature extractor 334.

In some embodiments, information produced by content analyzers 333 is forwarded to evidence database 342.

Evidence database 342 is configured to receive, store, and forward evidence related to the verdict reached for the classification of a particular URL. In some embodiments, evidence database 342 stores data that supports the classification of a URL. When a URL is malicious infected, the evidence in evidence database 342 can be used to help a URL owner clean up the URL.

In some embodiments, evidence database 342 is configured to receive and store information from any component within security system 301. For example, suppose content analyzers 333 classifies a particular URL as malicious. After classification, content analyzers 333 generates and forwards an evidence report to evidence database 342. The evidence report contains information which supports the malicious verdict reached by content analyzers 333 (e.g. the location of a malicious script tag in HTML).

In some embodiments, the information contained in evidence database 342 can be used by a URL owner to clean up a URL that has been classified as malicious. An employee of the security vendor may query a URL on evidence database 342 and receive the evidence which lead to the malicious classification associated with the URL. The employee may then send this evidence to the URL owner who can use it to clean up the URL. Upon confirming that the URL has been cleaned up, the security vendor may then reclassify the URL.

In this way, evidence database 342 can be used in web security pipelines such as those illustrated by processes 100 and 200.

In some embodiments, content analyzers 333 forwards analysis, data, resources etc. associated with a URL to compromised detector feature extractor 334.

In some embodiments, compromised detector feature extractor 334 receives information from content analyzers 333.

Compromised detector feature extractor 334 extracts one or more features that represent a URL using any information associated with a URL. In some embodiments, compromised detector feature extractor 334 uses information generated by content analyzers in the process of extracting features. Compromised detector feature extractor 334 outputs one or a number of features for each URL in a form that can be used by other components in security system 301, such as compromised detector ML model 336.

In some embodiments, features can be used to determine whether a malicious URL is malicious infected or malicious attacker owned.

Information associated with a URL may include graph connections associated with a URL, the security status of a particular plug-in, third-party information about a group of URLs, etc.

In some embodiments, one or more ML models (e.g. compromised ML model 336) are configured to use one or more features as inputs for inference of a URL's security classification. In some embodiments, features are representations of URLs. For example, a simple feature may represent the number of IOCs present within a certain URL. In some embodiments, features are complex and are extracted through various processes.

In some embodiments, security system 301 uses a variety of features to analyze URLs. In some embodiments, one or a plurality of features are used in any combination to analyze a URL. In some embodiments, one or more features are extracted/generated/produced etc. by various components in security system 301.

Features may be determined by using information external to security system 301. For example, a third_party_score feature may represent the number of security vendors that have flagged the URL as malicious as provided by a third-party. Other features are determined by using information internal to a particular security vendor, such as is_cr. The is_cr feature indicates if the URL has been previously requested reanalysis. Features can be determined by any combination of information, external and internal.

In some embodiments, features are content based and can be determined from accessing the content related to the URL. Content based features may also be determined using information associated with the URL. In some embodiments, the production of content based features is facilitated in part by content analyzers 333.

For example, a content based feature may be determined by parsing the HTML of a given webpage. An example of a content based resource is benign_cat. The benign_cat feature indicates a benign category of activities such as a shopping, e-commerce, government, etc. These features may come from a third-party source or an internal source.

In some embodiments, features are crawl based. Crawl based features can be determined by analyzing the networking transactions associated with a URL. In some embodiments, the production of crawl based features is facilitated in part by URL Crawler 322.

For example, a URL may receive one or a number of 200 OK HTTP requests upon being accessed. This is represented by the count200ok feature. On the other hand, a URL may forward one or a number of HTTP requests upon being accessed.

More examples of crawl based features include: ip_count, a count of distinct IPs that the URL resolves to when it is accessed; count_documents, a count of documents that were fetched when the URL was requested; requestcount, a count of HTTP requests that were fetched when the URL was requested; count301ok, a count of redirection (30x) HTTP requests that were fetched when the URL was requested; allcrawltraffichosts, a count of all distinct hostnames from which content was loaded when the URL was requested; count_malicioussh_as_is_navigation, count of malicious navigation frame; count_malicioussh_as_isframe, a count of malicious iframe; count_malicioussh_as_initiator_type_script, a count of malicious request initiator script, count_malicioussh_as_initiator_type_parser, a count of malicious scripts where browser's HTML parser initiated the request.

It should be understood that along with counts of items, features can also be based on the actual items. For example, referring to the count_documents feature, a feature can be based on the analysis of the content of the documents received.

In some embodiments, features are derived from the URLs content. For example, the URLs content may be queried on a ML model which returns the derived content based feature associated with the URL. One such feature is lexical_score which is derived from a deep learning ML model (e.g. 374) that returns a feature based on the characters which make up the actual URL string. It should be noted that content based features are not only derived from the characters in the URL. In another example, a feature can be derived from an analysis of content. For example, a ML model can derive a feature from the HTML file associated with a URL. In some embodiments, a third party or internal service generates features derived from the URLs content.

More examples of features include malicious_children, a count of known malicious children URLs in the same domain; domain_traffic_seen, a sum of all a security vendor's customer traffic seen to the URL in the past three months; pdns_age, the length of time (age) that a URL has existed in the database of a passive DNS service; pdns_ip_count, a count of distinct IP's that the hostname has resolved to in the past.

In some embodiments, a content based feature is generated by hybrid dynamic/static analysis of obfuscated and evasive JavaScript code. In some embodiments, JavaScript code is analyzed using static analysis. In some embodiments, JavaScript code is analyzed using dynamic analysis. In some embodiments, a content based feature is determined using an ensemble of deep learning (e.g. convolutional neural networks) and boosted random forest models to detect malicious JavaScript. In some embodiments, content based features are determined using a recursive knowledge check that extracts URL content from JavaScript and HTML and checks against known malicious URLs. In some embodiments, the known malicious URLs are received from sources external to security system 301 or are known internally.

In some embodiments, content based features are generated by a comparison to human generated sets of rules. For example, a human may generate a set of rules where a boolean is used to indicate if a URL conforms with a certain rule. A URL can be evaluated using this set of rules. This list of booleans can then be used to generate a feature.

In some embodiments, features are considered to be vulnerability based. Vulnerability based features can be determined by analyzing the construction of a resource (e.g. analyzing a websites JavaScript plugins). One example is cms_name, which is a categorical feature that identifies the content management systems (CMS) such as WordPress, Joomla, or Drupal, etc. Another example is cve_count, which is a count of common vulnerabilities and exposures (CVEs) likely to be impacting the sites due to an outdated configuration (e.g. an outdated plugin).

In some embodiments, external feature generator 382 returns a feature for a particular URL which is determined at least in part using information that is external to security system 301. In some embodiments, external feature generator 382 maintains a bilateral communication with external devices. External feature generator 382 communicates information, such as the URL, to the external devices and receives information about the URL which can then be used to determine a feature for the URL.

Examples of external devices which external feature generator 382 is in communication with include external APIs, services provided by the security vendor, databases maintained by the security vendor, etc.

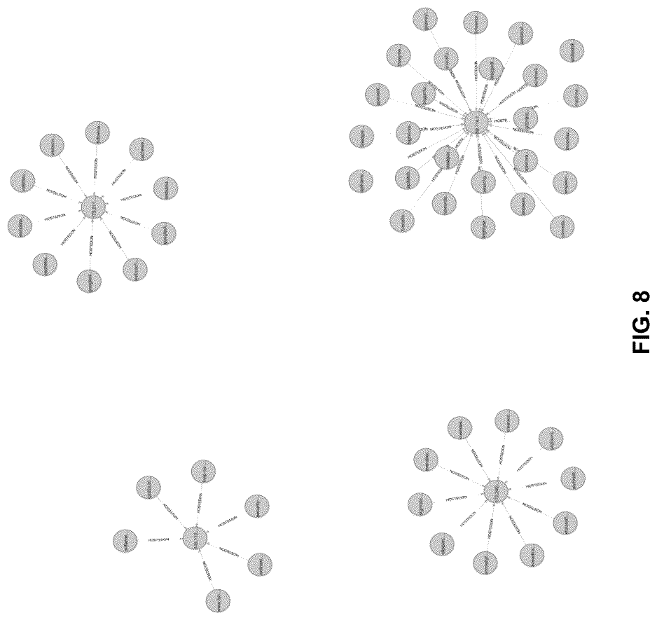

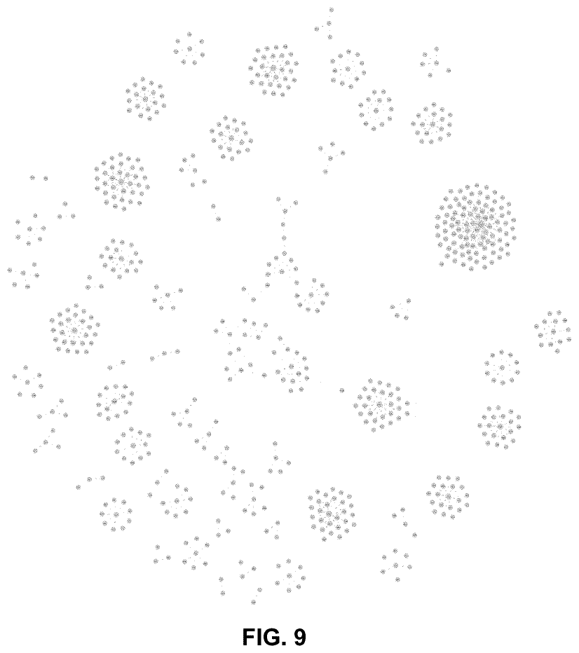

In some embodiments, features are derived from information associated with the URL. For example, some features are considered graph based and are generated using a graph database implementation (e.g. GraphDB 375). In some embodiments, GraphDB 375 contains a database of entities (e.g. URLs, information associated with URLs, other relevant information, etc.) which are stored in memory as nodes. The nodes are related to each other by edges. In some embodiments, a feature is derived from a particular URLs relation in a GraphDB. One such feature is the relative_third_party_score. This feature describes the number of third-party vendors that deem the URL malicious. The cluster is a star graph where the central node is an IOC and hostnames detected as compromised or attacker-owned surround it. Another feature is relative_lexical_similarity, which is the average similarity score of a given URL string with all other hostnames that share the same IOC. A third feature may be the relative_screenshot_similarity, which is the average similarity score of a screenshot of a page on the given URL (e.g. a homepage) compared with all other hostnames that share the same IOC. FIGS. 8 and 9 illustrate examples of clusters generated by a graph database. Other relative features may be derived from information associated with the URL.

The categories of features discussed herein are merely illustrative examples of features. Features may be amalgamations of each category. The systems and methods disclosed herein can create and use one or more features in any combination. The systems and methods disclosed herein can be configured to create and use any conceivable feature which describes one or more URLs.

In some embodiments, compromised detector feature extractor 334 extracts, produces, generates, determines, etc., any feature which is used to represent a URL.

In some embodiments, compromised detector feature extractor 334 extracts one or more features, which represent a URL, from information available to security system 301 (e.g. information associated with a URL).

Compromised detector feature extractor 334 can be configured to analyze the information in any manner (e.g. reading, parsing, etc.). In some embodiments, after analyzing information associated with a URL, compromised detector feature extractor 334 returns one or more features that represent the URL.

For example, compromised detector feature extractor 334 may query a URL's information and receive its content (e.g. JavaScript files) and metadata. In some embodiments, the content and metadata has been generated by a previous component (e.g. URL crawler 322). In some embodiments, content and metadata are produced by running code associated with the URL (e.g. JavaScript) in a sandbox. Compromised detector feature extractor 334 will then analyze the content and metadata and generate a feature associated with the content and metadata.

In some embodiments, compromised detector feature extractor 334 may query a URL's information, receive its content and metadata, and determine a crawl based feature. For example, compromised detector feature extractor 334 can determine the count200ok feature by determining the number of 200 OK HTTP requests that are sent to a device which accesses the URL. In some embodiments, the device that accesses the URL is a device within security system 301 (e.g. URL crawler 322).

In some embodiments, compromised detector feature extractor 334 receives any information associated with crawl based features from URL crawler 322.

In some embodiments, the compromised detector feature extractor 334 generates features such that the features can be used as inputs of a particular implementation of an ML model. In some embodiments, the classification of a URL is inferred by a Random Forest ML model (e.g. compromised ML model 336).

For example, if an ML model requires features to be formatted as a vector of numbers, the compromised detector feature extractor 334 generates a vector of numbers which represents the URL.

As an illustration, consider a feature that is based on a screenshot of a page associated with a URL. In some embodiments, compromised detector feature extractor 334 analyzes a screenshot of a page associated with the URL. Each pixel of the screenshot will have a red, green, and blue (RGB) value where the RGB values are represented by numbers. In some embodiments, compromised detector feature extractor 334 creates a matrix of values which describe each pixel of an image in terms of its position and RGB values. In some embodiments, compromised detector feature generator 334 transforms this matrix into one or a number of feature vectors. The feature vectors represent the URL in terms of the feature and can be used for inference by a ML model.

Features may be numerical features, categorical features, text features, time series/sequential data, image features, audio features, graph features, date/time features, binary features, sparse features, structured/unstructured data mix, etc. Features can be generated in a variety of ways. Features do not need to be vectors of numbers.

In some embodiments, compromised detector feature extractor 334 processes features out of band and makes the features available at detection time. In some embodiments, compromised detector feature extractor 334 forwards information associated with a URL to a separate system. The separate system receives the information associated with the URL, extracts the features for the URL, and forwards the features to a component in URL classifier 332. In some embodiments, the separate system is a computing device that is outside of security system 301. In some embodiments, the separate system is a component of security system 301.

In some embodiments, compromised detector feature extractor 334 uses any other component in security system 301, alone or in combination, to supplement or fully execute the process of extracting/producing features (e.g. external feature generator 382, internal feature generator 372, evidence database 342, data aggregation and secondary feature generator 362, etc.) Internal feature warehouse 352 is a database implementation in accordance with some embodiments. In some embodiments, internal feature warehouse 352 receives, stores, and provides access to information. In some embodiments, the entries include features, associated URLs, information associated with URLs, metadata, etc. In some embodiments, internal feature warehouse 352 facilitates rapid access to a particular feature for a particular URL which was generated at a previous time.

For example, a component within security system 301 may query internal feature warehouse 352 for the lexical_score of URL303a. In response, internal feature warehouse 352 determines if this feature is stored. In response to a determination that the feature is stored, it can rapidly forward the feature to the component.

In some embodiments, one or a number of components of security system 301 may input features into internal feature warehouse 352. In some embodiments one or number of components may access features by querying internal feature warehouse 352.

In some embodiments, the components of internal feature generator 372 (i.e. 373, 374, and 375) are configured to work in combination or alone to execute a process which generates features.

One or more ML models 374 use machine learning techniques to generate new features from information associated with a URL in accordance with some embodiments. Examples of ML techniques which are used in ML models 374 include linear regression, support vector machine, naïve Bayes, logistic regression, K-nearest neighbors, decision trees, gradient boosted decision trees, K-means clustering, hierarchical clustering, density-based spatial clustering of applications with noise (DBSCAN) clustering, principal component analysis, neural networks, etc.

In some embodiments, ML models 374 use secondary features as an input and output primary features which can then be used for URL classification (e.g. as input features for compromised ML model 336). In some embodiments, the secondary features are generated and provided by data aggregation and secondary feature generator 362. This process can also be iterative, such that one ML model outputs features which are inputs to another ML model which outputs features and so on, until primary features are generated.

For example, ML models 374 may include a convolutional neural network (CNN) which can detect malicious JavaScript code. In some embodiments, this CNN is used to generate one or more features which represents the presence of malicious JavaScript code in resources associated with a URL.

In some embodiments, internal feature generator 372 uses information associated with a URL to compute a feature that describes the URL. For example, GraphDB 375 uses associations between a plurality of URLs (some of which are not the URL which is being described) and axillary information to produce features.

In some embodiments, IOB service 373 receives information associated with a URL and investigates the URLs for indicators of beingness (IOBs). In some embodiments, IOB service 373 returns a feature which describes a URL.

In some embodiments, IOB service 373 provides the iob_score feature. The iob_score is an ML score indicating the beingness of a domain which is inferred by a ML model trained on a database comprised of the whois data, passive DNS, certificate information which is associated with a plurality of websites, etc.

In some embodiments, this ML analysis occurs asynchronously. In some embodiments, IOB service 373 is external to security system 301 and maintains bilateral communication with security system 301.

In some embodiments, GraphDB 375 is a graph database implementation. GraphDB 375 stores information in a graph structure. GraphDB 375 contains a database of entities (e.g. URLs, information associated with URLs, other relevant information, etc.) and their relations in a graphical representation.

In some embodiments, GraphDB 375 requires structured data prior to input. In some embodiments, a separate component structures the data. In some embodiments, GraphDB 375 structures the data.

GraphDB 375 provides a variety of advantages for producing features for URLs. Graph database implementations are used to rapidly compute graphical properties of large amounts of data. In some embodiments, GraphDB 375 is queried (by any component of security system 301) to return a graphical property of one or a number of URLs, such as path related properties or cluster related properties. In some embodiments, GraphDB 375 translates results of a query into a feature which describes a URL. GraphDB 375 forwards results of a query to another component which produces a feature.

GraphDB 375 facilitates the production of a variety of features relating to graphical representations. Examples of graphical features include relative_third_party_score, relative_lexical_similarity, relative_screenshot_similarity, etc.

In some embodiments, GraphDB 375 facilitates the generation of other metrics associated with URLs. In some embodiments, metrics produced by GraphDB 375 are used by other components to facilitate URL investigation.

For example, suppose GraphDB 375 contains a graphical representation of communication between a plurality of URLs (i.e. if URL 1 communicates with URL 2 then an edge connecting two nodes representing the URLs will be present). Further, suppose one URL in the plurality of URLs is malicious. GraphDB 375 can rapidly compute the shortest path between a queried URL and the one malicious URL. Therefore, the information about a queried URL's link to a malicious URL can be used to generate a feature that describes the URL. Further, if the shortest path to a malicious URL meets a certain threshold, security system 301 can immediately classify the URL as malicious.

In some embodiments, GraphDB 375 contains nodes which represent information other than URLs. For example, a node may represent an IOC. GraphDB 375 may be used to search for new campaigns. In some embodiments, GraphDB 375 is configured to alert a security vendor when certain graphical patterns become evident. In some embodiments, GraphDB 375 is configured to alert an entity (e.g. a component in security system 301 or an employee of the security vendor) when certain patterns become evident. One such pattern is referred to as a cluster.

In some embodiments, GraphDB 375 is used to detect new campaigns in real time. For example, suppose URL classifier 332 is receiving a continuous stream from the CR system of legitimate URLs that are potentially infected. When a URL is queried on URL classifier 332, URL classifier 332 determines communications with other URLs contained in each URL. For example, content analyzers 333 finds a link to a certain URL within the HTML of a plurality of URLs. In another example, URL crawler 322 produces crawl logs which indicate that requests are being made to a specific URL or set of URLs. URL classifier 332 forwards this information to internal feature generator 372.

Upon receiving the URLs and their communications from any source (e.g. CR system), GraphDB 375 generates a graphical representation of the plurality of URLs and the communications to a certain URL. Eventually, GraphDB 375 will demonstrate that there is a large number of potentially malicious URLs (which may also be legitimate) which all link to a certain URL or set of URLs (i.e. clusters).

Once GraphDB 375 demonstrates a connectivity with more than a threshold number of URLs, it may alert the security vendor.

In some embodiments, upon making such a determination, GraphDB 375 may query the one or several interconnected URLs on URL classifier 332. Upon a determination that the one or several URLs are malicious, GraphDB 375 has successfully uncovered a new campaign.

In some embodiments, GraphDB 375 produces and stores clusters which take the form of clusters depicted in FIGS. 8 and 9.

This example illustrates that security system 301 can use GraphDB 375 to respond to a stream of URLs and uncover a previously unknown campaign.

In some embodiments, GraphDB 375 is maintained by a security vendor to maximize its efficacy. In some embodiments, a cluster which exceeds a certain threshold of nodes is ignored, meaning no new nodes are inserted. In some embodiments, clusters that fall under a certain threshold for a certain period of time are deleted. In some embodiments, as a cluster grows and reaches a certain threshold, the security vendor is alerted.

External feature generator 382 is implemented on a computing device that may be internal to security system 301. In some embodiments, external feature generator 382 is implemented on a device that is external to security system 301 and connected to one or more devices within security system 301.

In some embodiments, external feature generator 382 receives a URL and/or information associated with a URL, generates a feature which describes the URL, and forwards a feature to another component. Information associated with the URL may be information that is retrieved from sources external to security system 301.

In some embodiments, external feature generator 382 facilitates access to external information for any component in security system 301.

There are many third-party resources which provide information that is useful for URL classifications. These third-party resources may be used in a process of generating features as well. Examples of third-party resources include ground truth data oracles.

In some embodiments, external feature generator 382 facilitates communication with a variety of external devices maintained by a security vendor. Examples of external devices which external feature generator 382 is in communication with include, URLC ML devices, external APIs, services provided by the security vendor, databases maintained by the security vendor, etc.

In some embodiments, data aggregation and secondary feature generator 362 receives data from components within security system 301, aggregates data in a manner which is useful for feature generation and forwards the aggregated data to other components in security system 301. In some embodiments, data aggregation and secondary feature generator 362 can be used to supplement any process that is executed by security system 301.

For example, suppose compromised detector feature extractor 334 forwards HTML files associated with a plurality of different URLs to data aggregation and secondary feature generator 362. Data aggregation and secondary feature generation 362 prepares the HTML files such that each can be forwarded and entered into GraphDB 375.

In some embodiments, data aggregation and secondary feature generator 362 injects streaming data of historical detections to generate new relational features. Data aggregation and secondary feature generator 362 may be configured to use previously generated information along with a live stream of information to generate new features in real-time.

In some embodiments, data aggregation and secondary feature generator 362 may generate secondary features which describe the URL. These features may then be used as the input for ML models 374 for inference.

In some embodiments, security system 301 generates features through the interoperation of one or more components.

It can be computationally expensive to query the features on a ML model in order to infer a security classification and to generate features. Therefore, it is often desirable to minimize the load on such a process.

In some embodiments, security system 301 implements a method to balance the load on components involving signatures. In some embodiments, signature generation involves a variety of components in security system 301 because it utilizes data generated by various components. In some embodiments, signature generation is facilitated by signature generator 392. In some embodiments, compromised signatures checker 335 checks the information associated with the URL (e.g. features, reports, resources directed to by the URL) against signatures.

In some embodiments, compromised signatures checker 335 determines if one or more signatures are exhibited by a URL. In response to a determination that a URL exhibits one or more signals, compromised signatures checker 335 alerts security system 301.

In some embodiments, the association of a signature with a URL indicates that the URL is malicious attacker owned. In some embodiments, the association of a signature with a URL indicates that the URL is also malicious infected.

In some embodiments, compromised signatures checker 335 receives a malicious URL and determines if the URL is malicious attacker owned or malicious infected. In some embodiments, compromised signatures checker 335 uses the signatures of known campaigns to determine that a URL is malicious infected. After compromised signatures checker 335 determines that a URL is malicious infected, it forwards the classification to URL classification DB 312. In some embodiments, compromised signature checker 335 forwards evidence of the malicious infected classification to evidence database 342.

In response to a determination that compromised signatures checker 335 cannot differentiate between malicious attacker owned and malicious infected; the URL, features, and information associated with the URL are forwarded to compromised ML model 336.

In some embodiments, signature generator 392 forwards one or a number of signatures to compromised signatures checker 335. In some embodiments, compromised signatures checker 335 maintains a plurality of signatures in memory and checks to see if a URL exhibits the signatures stored in memory.

In some embodiments, GraphDB 375 alerts signature generator 392 of a particular graphical pattern beginning to emerge. In some embodiments, the graphical pattern (e.g. a cluster) indicates an emerging signature. For example, upon a determination that a plurality of URLs (e.g. more than a threshold number of URLs) is connected to a certain newly discovered malicious URL, GraphDB 375 can communicate to signature generator 392 that any URL which links to the newly discovered malicious URL is likely also malicious. In response, signature generator can communicate this information to compromised signatures checker 335.

Now, when a new URL is encountered by compromised signatures checker 335, it will check to see if it is linked to the malicious URL (e.g. it exhibits the signature). In response to a determination that the new URL exhibits the signature, compromised signatures checker 335 reaches a verdict on a classification, forwards the URL and classification to URL classification DB 312, and alerts security system 301 to cease the investigation of the new URL. Thus, the signature generator 392 and compromised signatures checker 335 successfully conserved compute power in the analysis and classification of the new URL.

In another example, after a period of time ML models 374 may determine a strong correlation between certain inputs and malicious activity. In some embodiments, the inputs are features generated by data aggregation and secondary feature generator 362. Instead of inferring a primary feature, ML models 374 send secondary features to signature generator 392. Now, once it is determined that a URL exhibits these features, any component in communication with signature generator 392 can cease the investigation of the URL.

Signatures can consist of any information associated with the URL. Security system 301 can generate any signature and check any URL for any signature. The signature need not be a feature vector.

For example, suppose the URL associated with the website in FIG. 7A has been represented as a screenshot. This screenshot may be used as a signature. Compromised signature checker 375 can compare the screenshots of other URLs to this signature.

Signature generator 392 can generate signatures of known campaigns. In some embodiments, signature generator 392 is configured to receive a plurality of labeled URLs (i.e. URLs with a known classification) and extract one or more signatures. These signatures can be used by compromised signatures checker 335 to compare to new URLs and detect known campaigns.

In some embodiments, signature generator 392 uses external features 382 and internal features 372 to generate signatures for use in URL investigation.

In some embodiments, signatures are crafted by researchers and subject experts and are used to detect infected sites. In some embodiments, the signatures are represented as a set of rules (e.g. Yet Another Recursive Algorithm (YARA) rules). In some embodiments, information associated with URLs is converted to a form which allows for comparison to signatures, such as YARA. Sets of rules can be represented as any form of data including, JSON, YAML, TOML, CSV, etc.

In some embodiments, signature generator 392 receives information from external sources (e.g. third-party web-security services), configures the information as a signature, and forwards the signature for use in signature checking.

In some embodiments, compromised signatures detector 335 facilitates step 432 of process 400.

Compromised signatures checker 335 compares signatures of known campaigns to information associated with a URL. In response to a determination that the URL exhibits signatures of known campaigns, the URL is classified as malicious infected or malicious attacker owned. In response to a determination that the URL does not contain signatures of known campaigns, the URL is investigated further.

In some embodiments, a URL is queried on compromised ML model 336 for inference. In some embodiments, compromised ML model 336 represents one of the one or more ML models.

In some embodiments, compromised ML model 336 uses one or more features generated by one or more components within security system 301 as inputs for an inference of the classification of a URL.

In some embodiments, compromised ML model 336 is queried with a URL that is known to be malicious. Compromised ML model 336 receives the malicious URL, features, and any information associated with the URL and infers whether the URL is malicious attacker owned or malicious infected. In some embodiments, the inference is entered into URL classification DB 312. In some embodiments, evidence, such as features, which is used to reach the classification is forwarded and stored in evidence database 342.

In some embodiments, a URL is queried on compromised ML model 336 when other components in security system 301 are unable to reach a verdict on the classification associated with the URL.

In some embodiments, compromised ML model 336 returns a classification of a URL for use in other components of security system 301 (e.g. URL classification DB 312).

Compromised ML model 336 can return classifications of malicious, benign, malicious attacker owned, malicious infected, grayware, etc.

In some embodiments, compromised ML model 336 is configured to return classifications of malicious attacker owned or malicious infected.

In some embodiments, ML model 336 receives and uses one or a number of features from various entities alone or in combination as inputs for inference. Components of security system 301, such as internal feature generator 352, external feature generator 382, etc. may provide features as inputs.

In some embodiments, compromised ML model 336 is a Random Forest ML model. Compromised ML model 336 may be any machine learning process, such as: linear regression, logistic regression, support vector machine, naïve Bayes, logistic regression, K-nearest neighbors, decision trees, gradient boosted decision trees, extreme gradient boosted decision trees, K-means clustering, hierarchical clustering, density-based spatial clustering of applications with noise (DBSCAN) clustering, principal component analysis, neural networks, etc.

Compromised ML model 336 can be trained using a variety of methods. In some embodiments, the training data consists of features which correspond to URLs which are labeled with a known classification. In some embodiments, training features are analogous to the features generated by other components in security system 301. In some embodiments, compromised ML model 336 is trained by supervised learning training methods on features and labeled URLs. In some embodiments, ML model 336 trains on a large amount of training data which consists of a large number of labeled URLs. In some embodiments, ML model 336 is pre-trained and then used to infer the security classification of URLs.

In some embodiments, ML model 336 is constantly training in order to improve accuracy. In some embodiments, ML model 336 asynchronously trains on a stream of URLs made available by other components.

In some embodiments, a loss function is used to train ML model 336. Examples of loss functions include mean squared error, mean absolute error, Huber loss, cross entropy loss, hinge loss, Kullback-Leibler divergence, root mean square error loss, etc.

In some embodiments, ML model 336 is trained by performing inferences on training data, calculating the loss function of the inferences, and reconfiguring parameters that describe the ML model 336 to minimize the loss function.

In some embodiments, feature cache 337 is used by various components in security system 301 to rapidly access commonly used features. In some embodiments, feature cache 337 receives features generated by a variety of components within security system 301, such as compromised detector feature extractor 334, internal feature generator 372, external feature generator 382, etc. and stores them in memory.

FIG. 4 is a flow diagram illustrating a process for determining the classification of a URL in accordance with some embodiments. In the example shown, process 400 may be implemented by a security system, such as security system 301.

At 402, a URL is received. A URL may be received from a variety of sources. In some embodiments, a URL is received from a network user attempting to access a URL. In some embodiments, the URL is received from a device sending a plurality of URLs for the purpose of classification.

At 412, it is determined if the URL is malicious. In response to a determination that the URL is malicious, process 400 proceeds to 422. In response to a determination that the URL is not malicious, process 400 proceeds to 482.

In some embodiments, step 412 is implemented by one or more components within security system 301. In some embodiments, step 412 is implemented by URL crawler 322. In some embodiments, step 412 is implemented by content analyzers 333.

At 422, content and metadata associated with the URL are fetched. Content and metadata associated with the URL may be any information associated with the URL. In some embodiments, step 422 is implemented by one or more components within security system 301, such as content analyzers 333.

In some embodiments, in addition to fetching content and metadata, computation is executed on the content and metadata which may be useful for other steps in process 400. For example, features which describe the URL may be generated. In some embodiments, one or more components within security system 301 are used to generate features associated with the URL at step 422.

In some embodiments, signatures associated with the URL are generated at step 422. In some embodiments, one or a number of components within security system 301 are used to generate signatures associated with the URL at step 422.

At 432, it is determined if the URL is infected with a known campaign. In some embodiments, the determination at step 432 is facilitated by the information generated at 422. In some embodiments, signatures associated with the URL are compared with signatures of known campaigns, in order to determine if the URL is infected with a known campaign.

In some embodiments, step 432 is implemented by one or more components of security system 301. In some embodiments, step 432 is implemented by compromised signatures checker 335.

In response to a determination that the URL is infected by a known campaign, process 400 proceeds to 452. In response to a determination that the URL is not infected by a known campaign, process 400 proceeds to 442.

At 442, an ML model is queried with the URL. In some embodiments, the ML model is configured to return a security classification of malicious infected or malicious attacker owned. In some embodiments, step 442 is implemented by one or more components of security system 301. In some embodiments, step 442 is implemented by compromised ML model 336.

In response to a determination that the URL is malicious infected, process 400 proceeds to 452. In response to a determination that the URL is malicious attacker owned, process 400 proceeds to 472.

### At Step 452, the URL is classified as malicious infected.

At 462, information associated with the URL is used as training data. In some embodiments, the training data is used to train compromised ML model 336. In some embodiments, the training data is used to train the ML model which implements step 442. In some embodiments, 462 is optional. In some embodiments, 462 is performed for confident predictions.

At step 472, the URL is classified as malicious attacker owned.

At 482, the URL is classified as benign.

In some embodiments, at steps 452, 472, and 482 the classification is forwarded and stored in a database. In some embodiments, the classification is forwarded to and stored in URL classification DB 312. The classification may be used by a security vendor, security system, etc. in order to facilitate network security.

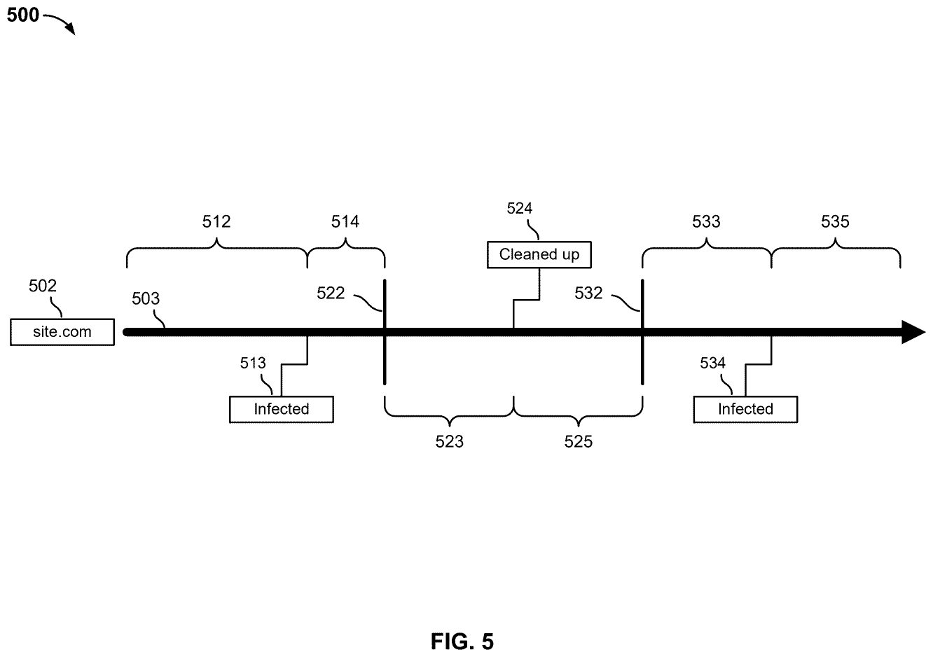

FIG. 5 is a timeline illustrating the lifecycle of a URL along with its security classification within a security system in accordance with some embodiments. In some embodiments, URL 502 is vulnerable to being infected. In some embodiments, URL 502 is a legitimate URL. In some embodiments, URL 502 is associated with websites illustrated in FIGS. 6A-6C. In some embodiments, the security system is security system 301.

In some embodiments, investigation 522 and investigation 532 are facilitated by one or more components within a security system, such as security system 301. Investigations 522 and 523 result in a security classification for URL 502, which is stored by the security system. In some embodiments, URL 502's security classification is stored in a URL classification DB, such as URL classification DB 312 and is used to determine if a user (e.g. user 302n) is allowed access to URL 502.

In some embodiments, at the beginning of timeline 503, URL 502 is known to be benign and is correctly classified as benign by the security system. Therefore, within period 512, URL 502 is a true negative (TN). In this period, the security system correctly allows users to access URL 502.

In some embodiments, URL 502 becomes infected as depicted by infection event 513. Infection event 513 indicates that once benign URL 502 is now malicious (e.g. a malicious party hacks a website and configures it to expose visitors to malware). In some embodiments, URL 502 is infected by a known campaign. In some embodiments, URL 502 is infected by an unknown campaign.

In some embodiments, after infection event 513, the security system does not investigate URL 502 until investigation 522. Therefore, within period 514, URL 502 is a false negative (FN) (i.e. URL 502 is misclassified). In some embodiments, the security system allows users to access URL 502 and exposes the users and the network to malicious activity.

Timeline 503 proceeds to investigation 522. In some embodiments, investigation 522 is initiated when URL 502 is crawled by a URL crawler, such as URL crawler 322. In some embodiments, investigation 522 is facilitated by one or more components the security system (e.g. security system 301), such as a URL classifier (e.g. URL classifier 332). In some embodiments, investigation 522 classifies URL 502 as malicious.

In some embodiments, investigation 522 classifies URL 502 as malicious infected. In some embodiments, the systems and methods disclosed herein enable the security system to differentiate between malicious infected and malicious attacker owned.

Upon a determination that URL 502 is malicious infected, the security system or the security system's administrator may respond differently than if URL 502 is classified as malicious attacker owned.

For example, the security system's administrator can contact URL 502's owner to clean up the website. The security system's administrator can minimize the amount of time that URL 502 is misclassified (e.g. FP and FN) if it can differentiate a malicious classification of malicious infected or malicious attacker owned.

In some embodiments, after investigation 522 correctly reclassifies URL 502 as malicious, URL 502 is a TP within period 523. During period 523, the security system correctly blocks access to URL 502 and protects users and the network from malicious activity.

Following period 523, URL 502 is cleaned up as depicted by clean up event 524. In some embodiments, clean up event 524 occurs when URL 502's owner notices that the URL is infected and extirpates all malignant properties of URL 502. After clean-up event 524, URL 502 is benign.

During period 525, URL 502 is misclassified as a false positive (FP) by the security system. URL 502 is benign, but it is classified as malicious. The security system mistakenly blocks access to URL 502. In some embodiments, this causes consternation amongst the security system provider's customers.

Timeline 503 proceeds to investigation 532. In some embodiments, investigation 532 is initiated when URL 502 is crawled by a URL crawler, such as URL crawler 322. In some embodiments, investigation 532 is facilitated by one or more components of the security system (e.g. security system 301), such as a URL classifier (e.g. URL classifier 332). In some embodiments, investigation 522 classifies URL 502 as benign.

During period 533, URL 502 is correctly classified as a TN. In some embodiments, the circumstances surrounding URL 502, and the security system are similar to those of 512.

In some embodiments, URL 502 gets reinfected as illustrated by infection event 534. However, the security system has not investigated URL 502 since investigation 532. Therefore, during period 535, URL 502 is a FN, and is not blocked by the security system. Thus, it can expose users to malicious activity.

In some embodiments, a malicious party that infects URL 502 at infection event 513 purposefully cleans up the infection of URL 502 at some point in timeline 503. This is done to induce the security system to reclassify URL 502 as benign and allow access to URL 502. Once access is reallowed, the malicious party can reinfect URL 502 and continue to expose visitors to malicious activity. This maneuver allows a malicious party to maximize the success of an attack.

Often times, an attacker owned URL will not be infected, cleaned up, reinfected, etc. Therefore, upon a determination that a URL is attacker owned, a security vendor can allocate less resources (e.g. computational resources for reinvestigation, human resources, etc.) in managing the URL.

Timeline 500 demonstrates how a malicious infected URL can lead to complexity in network security. It is desirable to know when a malicious URL is malicious infected, because this knowledge allows a security vendor to manage the URL more efficiently. Furthermore, malicious infected URLs are often legitimate URLs which are accessed often by a security vendor's customers.

The systems and methods disclosed herein allow a security vendor to mitigate complexity relating to timeline 500.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
extracting a plurality of features associated with a uniform resource locator (URL);
determining that the plurality of features associated with the URL do not match a known campaign;
in response to determining that the plurality of features associated with the URL do not match a known campaign, utilizing a machine learning model to determine whether the URL is infected;
labeling the URL based on an output of the machine learning model; and
updating a URL classification database based on the URL label, wherein network access to the URL is controlled based on the URL label.

2. The method of claim 1, further comprising crawling a plurality of URLs, wherein the plurality of URLs includes the URL.

3. The method of claim 1, further comprising receiving a change request for the URL.

4. The method of claim 1, wherein the URL is labeled as being malicious attacker owned.

5. The method of claim 1, wherein the URL is labeled as being malicious infected.

6. The method of claim 5, wherein the plurality of features associated with the URL are utilized to generate a new known campaign.

7. The method of claim 1, wherein the plurality of features associated with the URL include one or more external information features, one or more content-based features, one or more crawl-based features, and/or one or more graph signal features.

8. The method of claim 7, wherein the one or more graph signal features indicate the URL links to a cluster node.

9. The method of claim 7, wherein the one or more graph signal features indicate that the URL is infected in response to determining that a threshold number of URLs link to the cluster node.

10. The method of claim 7, wherein the one or more graph signal features indicate that a plurality of URLs communicate with the URL.

11. The method of claim 7, wherein the one or more graph signal features indicate that the URL is infected in response to determining that a threshold number of URLs link to the URL.

12. The method of claim 1, further comprising storing in an evidence database one or more of the plurality of features utilized by the machine learning model to label the URL.

13. The method of claim 1, wherein the machine learning model is a random forest model.

14. The method of claim 1, further comprising determining whether the URL is a benign or malicious, wherein the plurality of features associated with the URL are extracted in response to determining that the URL is malicious.

15. The method of claim 1, further comprising controlling network access to the URL based on the URL classification.

16. A system, comprising:
a processor configured to:
extract a plurality of features associated with a uniform resource locator (URL);
determine that the plurality of features associated with the URL do not match a known campaign;
in response to a determination that the plurality of features associated with the URL do not match a known campaign, utilize a machine learning model to determine whether the URL is infected;
label the URL as being infected based on an output of the machine learning model; and
update a URL classification database based on the URL label, wherein network access to the URL is controlled based on the URL label; and
a memory coupled to the processor and configured to provide the processor with instructions.

17. The system of claim 16, wherein the processor is configured to crawl a plurality of URLs, wherein the plurality of URLs includes the URL.

18. The system of claim 16, wherein the processor is configured to receive a change request for the URL.

19. The system of claim 16, wherein the plurality of features associated with the URL include one or more external information features, one or more content-based features, one or more crawl-based features, and/or one or more graph signal features.

20. A computer program product embodied in a non-transitory computer readable medium and comprising computer instructions for:
extracting a plurality of features associated with a uniform resource locator (URL);
determining that the plurality of features associated with the URL do not match a known campaign;
in response to determining that the plurality of features associated with the URL do not match a known campaign, utilizing a machine learning model to determine whether the URL is infected;
labeling the URL as being infected based on an output of the machine learning model; and
updating a URL classification database based on the URL label, wherein network access to the URL is controlled based on the URL label.
